(19) United States
(12) Patent Application Publication
(10) Pub. No.: US 2025/0018234 A1
(43) Pub. Date: Jan. 16, 2025

(54) SYSTEM AND METHOD FOR WILDFIRE MITIGATION

(71) Applicant: H2OSAZE, INC., Homestead, FL (US)

(72) Inventor: Paul Lucius MARTIN, Robins, GA (US)

(21) Appl. No.: 18/549,065

(22) PCT Filed: Mar. 27, 2023
(86) PCT No.: PCT/US2023/016416

§ 371 Date: Sep. 5, 2023

Related U.S. Application Data
(60) Provisional application No. 63/362,567, filed on Apr. 6, 2022.

(51) Int. Cl. A62C 3/02

(52) U.S. Cl. CPC A62C 3/0292

(57) ABSTRACT

An apparatus and method for delivery of a fire retardant/fire suppressant substance with a localize system thereby providing on-site protection and wildfire management in a cost effective and efficient manner. The system includes a fire retardant/fire suppressant substance storage system and a nozzle cannon assembly for delivery of the substance, where the nozzles are heat sensor guided for pinpoint accuracy. The nozzles for one implementation can provide various substance delivery spray patterns. The system includes various heat sensors and various other sensors including vision sensors and air moisture sensors for sensing the environmental conditions. The system can also have a smart computer based learning system that stores, updates and analyzes data related to the surrounding terrain conditions and topography.

### CROSS-REFERENCE TO RELATED APPLICATIONS

This Application claims priority to and the benefit of U.S. Provisional Patent Application Ser. No. 63/362,567, filed Apr. 6, 2022, entitled System and Method for Wildfire Mitigation, whereby the contents of the referenced priority application are incorporated herein by reference in their entirety.

### BACKGROUND

### Field

This technology as disclosed herein relates generally to environmental hazard mitigation methods and systems and, more particularly, to wildfire mitigation methods and systems.

### Background of Art

Climate change, population increases and other factors are considered by many to be the reason for an apparent increase in natural disasters over the last thirty years. There has been an apparent increase in violent tornadic activity, hurricanes, earthquakes and wildfires. Of these natural disasters, wildfires are a type of disaster that can be managed with the right systems in place. It has been estimated that every year since 2015, wildfires have set new records across the globe in at least the following categories—1. Size and intensity. 2. Number of wildfires. 3. Cost of damage and property loss. 4. Increase in wildfire suppression cost. 5. Level of toxic smoke emitted. The economic and environment impact is enormous and the impact will be felt for years to come. The cost associated with the suppression of wildfires combined with the cost associated with property loss and the related insurance claims is astronomical by itself. However, the cost can be 30 times more for cleanup and restoration. An uncontained wildfire burning for two weeks has been estimated to potentially release as much methane and carbon dioxide as all the cars and industry in that area produce in one year. Further, the wildfire increase will arguably be self-perpetuating, potentially causing the climate to warm, which can increase the likelihood of more wildfires.

Wildfires will continue to occur and in some sense wildfires that are less in size and less intense are natural and are arguably necessary for maintaining healthy forests by purging debris that can choke outgrowth. However, the size and intensity of the wildfires that we are now seeing across the globe not only are not good for the ecosystem, but results in enormous loss of property. Local agriculture is negatively impacted. The taxpayers at the local and federal level bear a huge cost. There is the loss of homes and businesses that impact families. Often wildfire insurance premiums double year-to-year or are cancelled altogether. Healthcare costs are impacted due to smoke induced health issues.

Managing wildfires and preventing wildfires from destroying property and mitigating their spread has proven challenging when using current methods. While it is known that water and/or other fire retardant substances can be utilized to extinguish and control a fire, current delivery systems are wholly inadequate to deal with the wildfires we are experiencing today. Further the current delivery systems are not designed to address and adapt to the varying environmental conditions surrounding a wildfire and the fuel that is sourcing the wildfire. The current delivery systems are also very inefficient and by the time they are implemented, the size of the wildfire may have increased by as much as 30% to 50%. Firefighting aircraft can be grounded due to high winds and/or low visibility. Large planes have to fly too fast and too high to accurately drop any fire retardant substance. The turn-around time from reloading the fire suppressant substance on the aircraft and the return flight is too slow to manage a fast spreading wildfire. Smaller aircraft and/or drones can't carry enough fire suppressant substance to be effective. This method is costly, and inefficient. Using aircraft in this fashion can be compared to an inefficient water bucket brigade when fighting the larger and faster spreading wildfires that we are seeing today. Home fire sprinkler systems have an extinguishing mist that is extremely fine and will be made ineffective by the least amount of wind. They also have limited storage for any chemical based system. Also, they may be able to extinguish embers or some hot spots, but not an actual 2000° F. wildfire. The fire will melt or burn all the equipment. It is also difficult to determine when to activate the system so as to not run out of foam or other retardant. Fire Activated Canister Extinguishers are another type of system that have been utilized but can only store and dispense a very small amount of extinguishing agent that is insufficient to extinguish the fire. The agent delivery system is low pressure, and is only able to extinguish small grass fires not wildfires, and the fire has to be too close to the building to activate the canister. Thermo-Gel Homeowner Protection is another type of protections system, however, protection will only last for 2 hours after application, and is not designed for high intensity fires. It is also difficult to determine when to apply gel. Aluminized Structure Wrap is yet another system that works by wrapping the home or structure in essentially aluminum foil, using hundreds of staples to hold it to the house. This takes too long to install and difficult to determine when and if to install. Also, it only lasts up to 10 minutes and is not made for a sustained wildfire assault. Other factors that may interfere with these older methods are: extremely high temperatures often present in forest fires, significantly as compared to house fires; the much larger two dimensional surface area of a heat front as compared to a localized spread, for example from within a home; the three dimensional volumetric fill capacity of a forest fire (for example imagine a flood's capacity for destruction as compared to an internal burst water main); the fourth dimensional temporal capacity of a forest fire's body to overwhelm nature and man-made structures alike, moving up to 12 miles per hour in the right conditions (e.g. wind, open grassland type conditionals similar to a wind fetch on the sea, uphill terrain, etc.) and even faster at the localized forest fires extensions due to things like the Venturi Effect, Bernoulli's principle, and other localized applications of fluid dynamics.

An effective wildfire management system is a long felt and unmet need. A better apparatus and/or method is needed for improving the delivery of fire retardant substances to manage wildfires, and is targeted to protect more important assets while protecting the overall ecosystem, and has the ability to adapt to various environmental and fuel source conditions.

### SUMMARY

The technology as disclosed herein includes a method and apparatus for delivery of a fire retardant/fire suppressant substance with a localize system thereby providing on-site protection and wildfire management in a cost effective and efficient manner. The system includes a fire retardant/fire suppressant substance storage system and a nozzle cannon assembly for delivery of the substance, where the nozzles are heat sensor guided for pinpoint accuracy. The nozzles for one implementation can provide various substance delivery spray patterns. The system can include various heat sensors and various other sensors including vision sensors and air moisture sensors for sensing the environmental conditions. The system can also have a smart computer based learning system that stores, updates and analyzes data related to the surrounding terrain conditions and topography. Given the system's ability to manage and hinder the spread of wildfires into critical areas, the cost associated with installation and maintenance of the system is far outweighed by the cost savings that will be seen and the mitigation of long term negative economic and environmental impacts.

The localized self-contained suppression system as disclosed and claimed herein provides a 24 hour/7 days a week (“24/7”) monitoring and suppression system. For one implementation of the technology, the suppression system stands as high as 40 feet tall or more such that the tower elevates the nozzle assembly to a height of 40 feet or more. The height of the system may vary depending on the terrain and the topography and the height density of a proximate tree line or any other natural or man-made obstruction. For one implementation the tower is 15 feet to 25 feet in height thereby elevating the nozzle to about 15 feet to 20 feet in height. In one implementation, the maximum height can be increased by an extension of a system part(s). One implementation is a computer based system where the computer or controller has been modified with software code, firmware and/or hardware in order to control the processes for controlling the environmental field sensors and thereby providing an autonomous system.

In addition to a self-contained fire suppressant substance storage system, the system for one implementation includes a self-contained electrical power system, which can comprise a solar-powered backup system or a gas based electrical generator. For one implementation, the system generates a substantially impenetrable approximately 30 feet wall of water or other fire suppressant substance at a 70 yard perimeter. The system can accommodate for varying terrains and ground slopes. The system does not require any human interaction to perform its task. One implementation of the system includes the installation of delivery systems about the perimeter of an area to be protected that are automatically controlled to emit a fire suppression substance, such as water or other fire retardant substance, using a targeted large emission of sufficient volume and pressure to extinguish an approaching fire. For one implementation of the technology, a single stand-alone system includes a storage system for a fire retardant substance. The single system can include a storage vessel that stores approximately 12,000-40,000 gallons of a fire-retardant substance such as water. In comparison, the largest and rarest firefighting aircraft (DC-10) can hold up to 36,000 gals. The next largest aircraft is the C-130 which can only hold 6,900 gal. Helicopters have an even smaller payload limit. A typical Home Fire Sprinkler System only stores up to 100 gal of foam or retardant. If such a system is not connected to municipal water supply, it only stores up to 100 gal of water. A Fire Activated Canister Extinguisher has a very small amount of extinguishing agent, one to two gallons. A Thermo-Gel Homeowner Protection is a one-time 2-hour spray on protection that is sold in gallon jugs for homeowners to decide when to apply and how much. Aluminized Structure Wrap comes in extra-large rolls of foil which can pose a storage problem.

For one implementation of the technology as disclosed and claimed herein, when a system is implemented, an abatement zone is utilized, which is an area that precedes the water coverage area (2,000-4000 yd. sq.), that consists of fire-resistant vegetation, which lowers the speed and intensity of the wildfire. The system uses area sensors immediately outside the mitigation area (10,000-17,000 yd. sq.) to relay crucial environmental and fire data to the system's computer which accurately determines the size, location, movement and intensity (including temperature and rate of spread) of the fire. The computer activates the water pumps and computer-guided water cannons for a precise and efficient extinguishment of a fire. The water cannons deliver a targeted 12,000-40,000 gal of water in 3-13 minutes over a 2,000-4,000 yd.² area. The computer then deactivates the pumps and water cannons and performs a scan of the affected area for potential re-flash conditions and begins replenishing the storage vessels with water or other fire retardant substances. For comparison, Firefighting Aircraft, such as, the DC-10 and the C-130 aircraft are too large to get close enough to be accurate or efficient with their deployment of the extinguishing agent. The DC-10 and C-130 drop a lot of water, but too quickly and don't cover enough area to thoroughly extinguish the fire and drench the ground deep enough to prevent a re-flash. It takes too much time to reload their extinguishing agent which gives the fire time enough to proliferate or re-flash before it can return. Helicopters simply can't carry enough water to be effective. Home Fire Sprinkler System's extinguishing mist is extremely fine and will be made ineffective by the least amount of wind. Fire Activated Canister Extinguishers are activated by the heat from the fire. If the wildfire is close enough for it to activate, it is too late to prevent fire from destroying areas of concern. Thermo-Gel Homeowner Protection systems use a home water hose to apply, and the application accuracy is insufficient. Aluminized Structure Wrap protects a structure for only a few minutes.

The technology as disclosed and claimed herein and its various implementations provide 24 hour coverage, seven days a week and 365 days a year (“24/7/365”) due to its automated monitoring, detection and mitigation systems. Firefighting Aircraft can take hours to deploy once notified. Home Fire Sprinkler Systems depend on the homeowner's judgement as to when to activate since there is limited storage. The homeowner may not be home at the time of the fire to activate the system. Fire Activated Canister Extinguisher systems are always available but have only a gallon of suppressant and the fire has to get too close to the house to activate the canister. Thermo-Gel Homeowner Protection has to be retrieved from storage area then connected to a water hose to be deployed. It only comes in gallon jugs so the homeowner has to switch out jugs when one is empty, which takes time. Then it depends on the homeowner's judgement as to when to apply the gel since it only protects for a short time period. Aluminized Structure Wrap has to be brought out of storage, unrolled, then fitted around the structure, then stapled to the structure, only if it's wooden.

For one implementation of the system, water dispensing cannons are elevated to a height of 40 ft, which can vary depending on the surrounding topography. For one implementation, the system as disclosed and claimed is self-contained, including a water supply tank and power backup systems including one or more of a solar powered backup system and a generator including one or more of a natural gas powered generator and a propane gas generator. The system as disclosed and claimed has the ability to protect an area of 10,000-17,000 square yards. One implementation of a single system includes 4 water cannons capable of dispensing 12,000-40,000 gal of water in 3-13 minutes over a 2,000-4,000 yd.². One implementation of the technology utilizes self-activating technology or optionally can be remotely/manually control by firefighters or customers. The self-activating technology includes field sensors and an onsite computer modified with controller hardware and software. The field sensors measure air temperature, ground temperature, wind velocity and direction, barometric pressure, temperature of the fire area, heat release rate, height of flames, oxygen/nitrogen levels, oxygen/nitrogen consumption (molar flow rates of incoming gases vs exhaust gases) rates, relative humidity, air temperature (91° F.), and specific heat capacities and relative humidity. The data is fed to an onsite computer, then is modified by hardware and software that analyzes the data and then determines the optimal spray pattern and direction of spray. After a fire has been mitigated, the computer is programmed to deactivate the system and algorithms are executed to direct the sensors to perform a scan of the affected area to determine potential re-flash conditions. There are a plurality of configurations for varying protection zones. The system can be customized for the most difficult terrains as well as custom paint options to camouflage the system. In one implementation, the system's major components are made of galvanized steel for reliability. In other implementations, various other materials, and modifications and hybrid material types hereof, can be used (such as cross-linked Polyethylene (“PEX”)) depending on various factors, such as the normal on-site conditions 24/7/365 and the more extreme conditions due to regular variability and that of climate change, whatever its overarching cause. For example, acid rain can be particularly corrosive to metals, whereas synthetic plastics are often resistant. Similarly, abrasive wind conditions may suggest a specific major component material and/or other particularized material adaptations and modifications for particular environmental factors as they may become more dramatic as time passes. In order to increase the efficacy of a system, the landscape that precedes the water coverage area can be redesigned into an area that can be referred to as an abatement zone. The abatement zone can include fire-resistant vegetation that acts to lower the intensity of the wildfire before the fire reaches the water coverage area.

Testing has shown the efficacy of the system and the approximate amount of water and the flow rate it takes to extinguish a high intensity wildfire. The onsite computer can be modified with hardware and algorithms to control the dispersant flow rate and spray pattern based on test data and the computer includes a learning function that uplinks actual performance data that can be utilized to modify the algorithms in real-time.

The features, functions, and advantages that have been discussed can be achieved independently in various implementations or may be combined in yet other implementations further details of which can be seen with reference to the following description and drawings.

The need for such a system as disclosed and claimed herein is evident in that it is configured to drastically reduce the estimated $300 to $400 billion a year in damages and losses. These and other advantageous features of the present technology as disclosed will be in part apparent and in part pointed out herein below.

### BRIEF DESCRIPTION OF THE DRAWING

For a better understanding of the present technology as disclosed, reference may be made to the accompanying drawings in which:

FIGS. 1A through 1G are an illustration of a wildfire suppression system including an above ground tank;

FIGS. 2A through 2F are an illustration of a wildfire suppression system including a below ground tank;

FIGS. 3A through 3G are an illustration of an above ground tank showing one implementation dimensions as shown, but not intended to limit the scope of the size of the vessel;

FIGS. 4A through 4D are an illustration of a nozzle/water cannon tower for a system with an above ground tank;

FIGS. 5A through 5C are an illustration of an above ground tank showing one implementation dimensions as shown, but not intended to limit the scope of the size of the vessel;

FIG. 6 an illustration of a below ground tank;

FIGS. 7A through 7E are an illustration of a tower top end;

FIGS. 8A through 8D are an illustration of a nozzle/water cannon tower for a system with a below ground tank;

FIG. 9 is an illustration of the process flow for monitoring and system activation;

FIG. 10 is an illustration of a system with three dispensing towers;

FIGS. 11A and 11B are an illustration of Spray Pattern D;

FIGS. 12A through 12C are an illustration of Spray Pattern M;

FIG. 13 is an illustration of Spray Pattern T;

FIG. 14 is an illustration of one implementation, an initial Spray Pattern F, proceeding all other spray patterns;

FIG. 15 is an illustration of Spray Pattern T with 3 second intervals;

FIGS. 16A and 16B are an illustration of Spray Pattern P;

FIG. 17 is an illustration of Spray Pattern R in a 4NS system;

FIGS. 18A and 18B are a further illustration of Spray Pattern D;

FIGS. 19A through 19C are a further illustration of Spray Pattern M;

FIG. 20 is a further illustration of Spray Pattern T;

FIG. 21 is an illustration of one implementation, an initial Spray Pattern F, proceeding all other spray patterns;

FIG. 22 is a further illustration of Spray Pattern T;

FIG. 23A and 23B are an illustration of Spray Pattern P;

FIG. 24 is an illustration of Spray Pattern—R in a 3NS system;

FIG. 25 is an illustration of Spray Pattern—W; and

FIG. 26 is an illustration of Spray Pattern—Z.

While the technology as disclosed is susceptible to various modifications and alternative forms, specific implementations thereof are shown by way of example in the drawings and will herein be described in detail. It should be understood, however, that the drawings and detailed description presented herein are not intended to limit the disclosure to the particular implementations as disclosed, but on the contrary, the intention is to cover all modifications, equivalents, and alternatives falling within the scope of the present technology as disclosed and as defined by the appended claims.

### DESCRIPTION

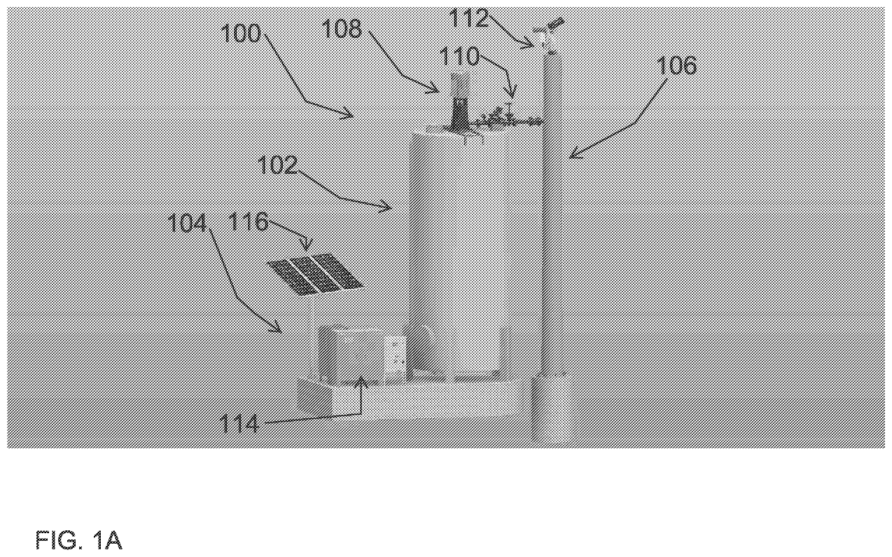

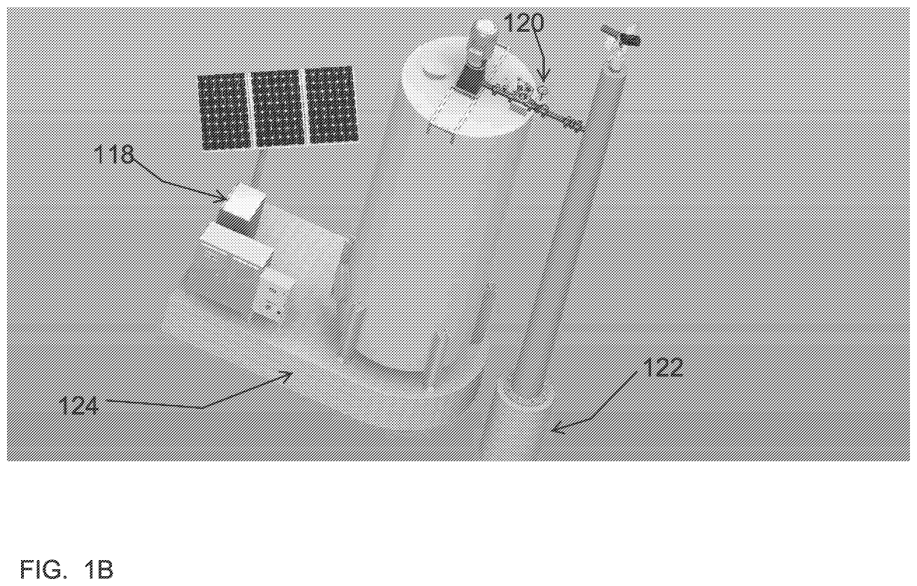

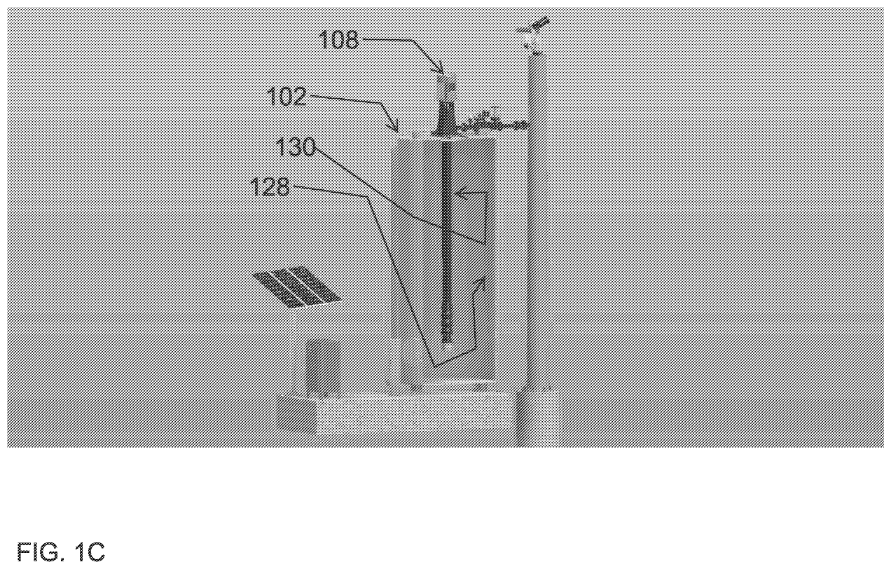

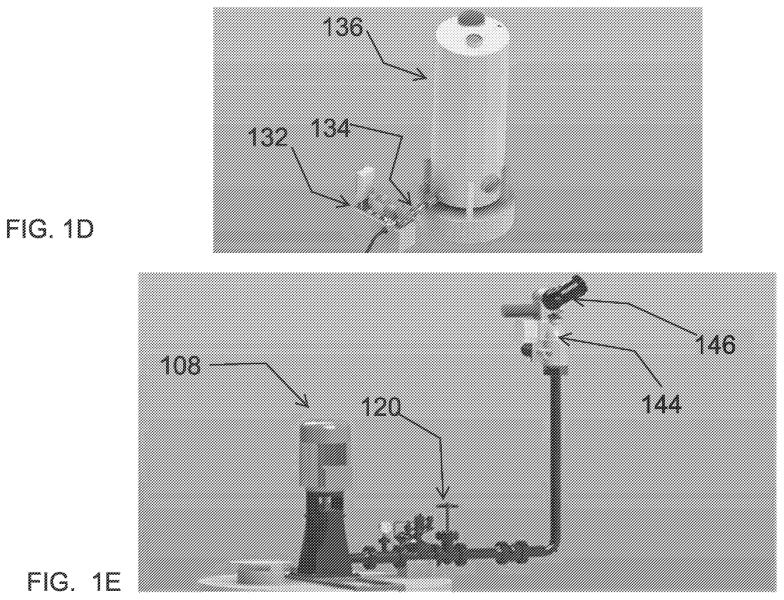

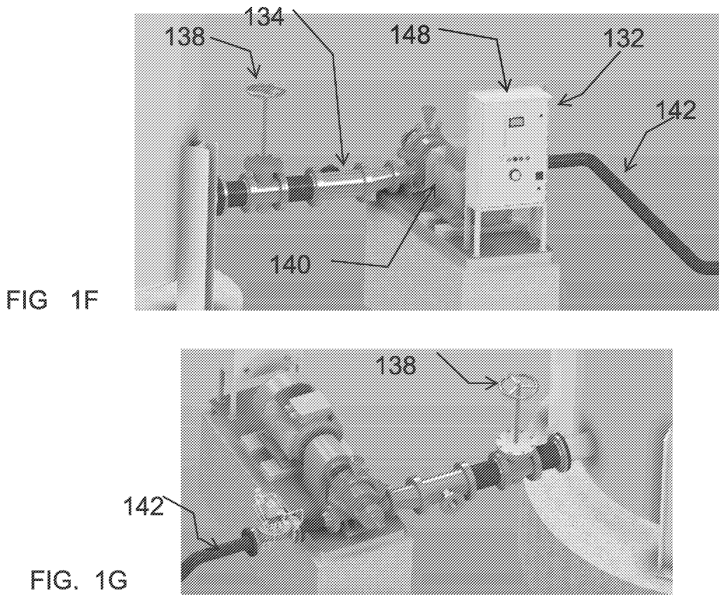

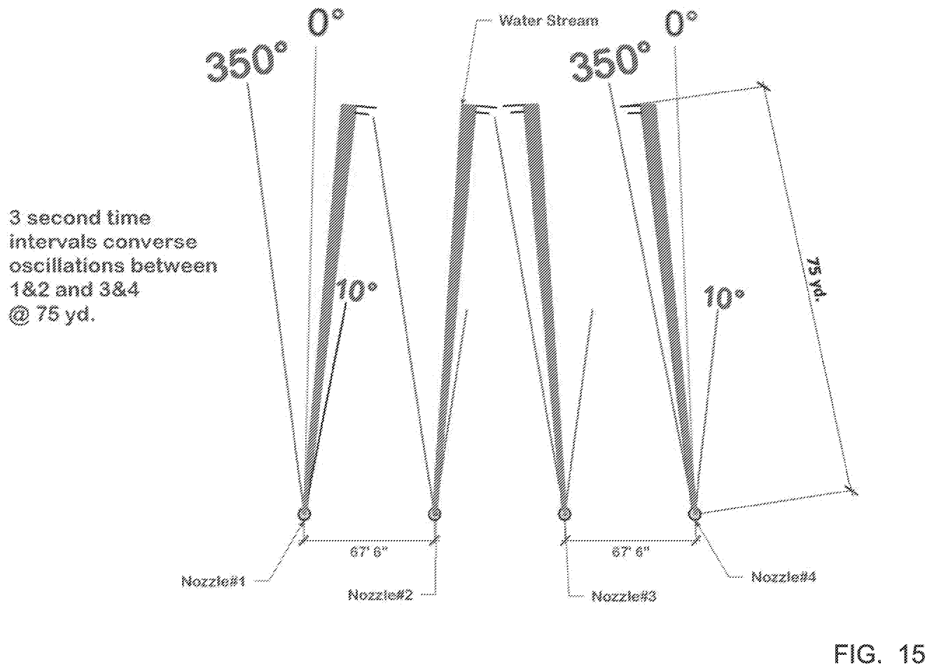

According to the implementation(s) of the present technology as disclosed, various views are illustrated in FIGS. 1-26 and like reference numerals are being used consistently throughout to refer to like and corresponding parts of the technology for all of the various views and figures of the drawings. Also, please note that the first digit(s) of the reference number for a given item or part of the technology should correspond to the Fig. number in which the item or part is first identified. Reference in the specification to “one embodiment” or “an embodiment”; “one implementation” or “an implementation” means that a particular feature, structure, or characteristic described in connection with the embodiment or implementation is included in at least one embodiment or implementation of the present technology. The appearances of the phrase “in one embodiment” or “in one implementation” in various places in the specification are not necessarily all referring to the same embodiment or the same implementation, nor are separate or alternative embodiments or implementations mutually exclusive of other embodiments or implementations. “3NS” means three (3) nozzle and 3 nozzle system as applicable; “4NS” means four (4) nozzle and 4 nozzle system as applicable. 1, 2, 3, 4 is Left to right. The terms “tower,” “cannon tower,” “elevated tower,” “nozzle tower,” “water cannon tower,” and “dispensing tower” can be used interchangeably herein. The terms “canon,” “nozzle,” “nozzle cannon assembly,” “nozzle assembly,” “water dispensing cannon,” “water cannon,” and “nozzles/water-cannon” can be used interchangeably herein. The perspective from which the nozzle array system is described is from a perspective behind the nozzle array and facing in the direction of a threat area.

One implementation of the present technology as disclosed comprising wildfire detection and suppression systems teaches a novel apparatus and method for fighting wildfires. One purpose of the technology as disclosed and claimed herein is to efficiently and effectively mitigate a wildfire threatening communities in Wildland-to-Urban interface areas. Each system is positioned about the perimeter of the area to be protected. Each system has an array of nozzles/water-cannons that face outward from the area to be protected in the direction of a potential oncoming wildfire. Each nozzle has a center outlet through which water or other fire retardant substance is emitted perpendicularly with respect to the nozzle face, which is considered a zero-degree projection. Preferably each system has a nozzle array including 3 or 4 nozzles, however, fewer or more nozzles can be used per system depending on the application. For a four nozzle array configuration, the centerline is between nozzles 2 and 3, and for a three nozzle array configuration the centerline is nozzle 2. The number of nozzles in an array for a given system can depend on the desired water coverage area (WCA). The centerline of a 4NS nozzle configuration is between nozzles 2 and 3, and the centerline is nozzle 2 for a 3NS nozzle configuration.

For the technology as disclosed and claimed herein, the following is a general reference for wildfire categories and intensity level:

### Fire Level Intensity Before Abatement Zone

HI—High Intensity 6,000-10,000+ kW/h
MI—Medium Intensity 3,000-5,999 kW/h
LI—Low Intensity up to 2,999 kW/h

### Wildfire Categories for System Programming Only

*All of the below wind velocities are sustained velocity with low to medium humidity
A1—Slow-moving, flat terrain, grass/shrubs, 0-8 kph wind
A2—Slow-moving, flat terrain, shrubs/trees, 0-8 kph wind
A3—Slow-moving, uphill, grass/shrubs, 0-8 kph wind
A4—Slow-moving, uphill, shrubs/trees, 0-8 kph wind
A5—Slow-moving, downhill, grass/shrubs, 0-8 kph wind
A6—Slow-moving, downhill, shrubs/trees, 0-8 kph wind
B1—Moderate-moving, flat terrain, grass/shrubs, 9-23 kph wind
B2—Moderate-moving, flat terrain, shrubs/trees, 9-23 kph wind
B3—Moderate-moving, uphill, grass/shrubs, 9-23 kph wind
B4—Moderate-moving, uphill, shrubs/trees, 9-23 kph wind
B5—Moderate-moving, downhill, grass/shrubs, 9-23 kph wind
B6—Moderate-moving, downhill, shrubs/trees, 9-23 kph wind
C1—Fast-moving, flat terrain, grass/shrubs, 24+ kph wind
C2—Fast-moving, flat terrain, shrubs/trees, 24+ kph wind
C3—Fast-moving, uphill, grass/shrubs, 24+ kph wind
C4—Fast-moving, uphill, shrubs/trees, 24+ kph wind
C5—Fast-moving, downhill, grass/shrubs, 24+ kph wind
C6—Fast-moving, downhill, shrubs/trees, 24+ kph wind
   Various nozzle angles will be required for efficiency and effectiveness because the slope of terrain will vary depending on location of system. The nozzle angle is programmed once the system is fully installed. For one implementation of the technology as disclosed and claimed herein, the nozzles are 65′-70′ apart.
   For one implementation the nozzles are about approximately 67′6″ apart in a regular coverage system spray pattern, but the nozzles in an extended coverage system spray patterns W and Z are 150′ apart.

The details of the technology as disclosed and various implementations can be better understood by referring to the figures of the drawings. Referring to FIGS. 1A through 1G an illustration of a wildfire suppression system including an above ground tank is provided. One implementation of a wildfire suppressant system 100 includes an above ground tank or other container 102 utilized for onsite storage of a fire suppressant substance such as water. One implementation of the system 100 includes a nozzle tower 106 that is utilized to elevate the nozzle array for effectively dispersing the fire suppressant substance over a desired area. One implementation of the system includes a local standalone power plant 104 sufficient to locally and independently power the system. The power plant includes one or more of a solar cell power source and electrical storage system 116 and a gas (natural gas and/or propane) powered electrical generator 114. The system includes a heat and vision system array 108 for sensing an oncoming wildfire. A flow control channel 110 controls the flowrate and pressure of the fire suppressant substance flowing from the tank and through the nozzle assembly 112.

For one implementation of the technology as disclosed and claimed herein, the power plant 104 and the tank 102 are supported on a reinforced concrete pad 124. The cannon tower 106 is supported on a concrete pillar 122. The flow control channel 110 includes a control valve 120. FIG. 1C illustrates a sectional view of the tank 102, thereby disclosing the interior and the interior of the tank wall 128. A syphoning channel 130 is also disclosed that is utilized to channel the fire suppressant substance from the interior volume of the tank to the cannon for dispensing the fire retardant substance. FIG. 1D illustrates a pump system 132 that is powered by the power plant. The pump system pumps through the pump line 134 that is connected between the pump system and the tank. The pump system, through the pump line 134, forces substance from the tank 136 and through the cannon assembly 144 and the nozzle 146. The pump system 132 includes a feed line 142 to a pump 140 that pumps through the pump exit line 134 and on to the tank. The pump includes a controller assembly 148 that regulates and controls the pump output. The pump line 134 includes a shutoff valve 138.

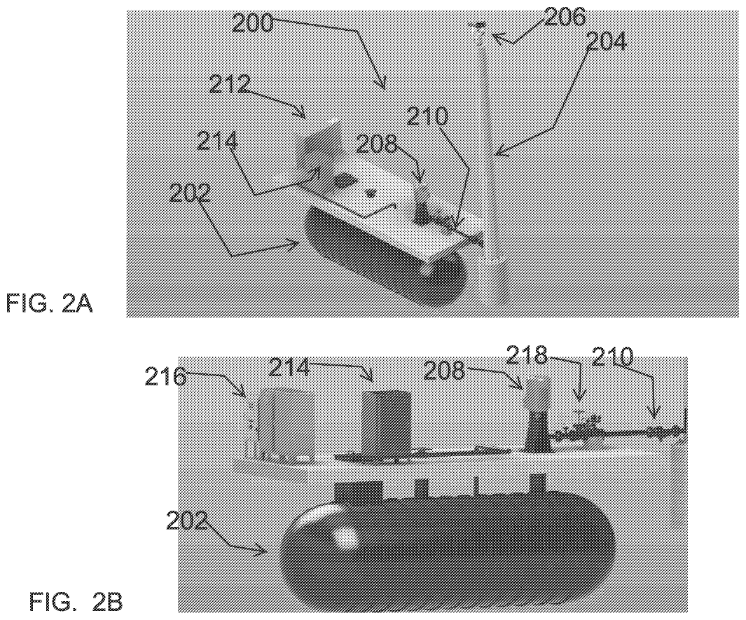

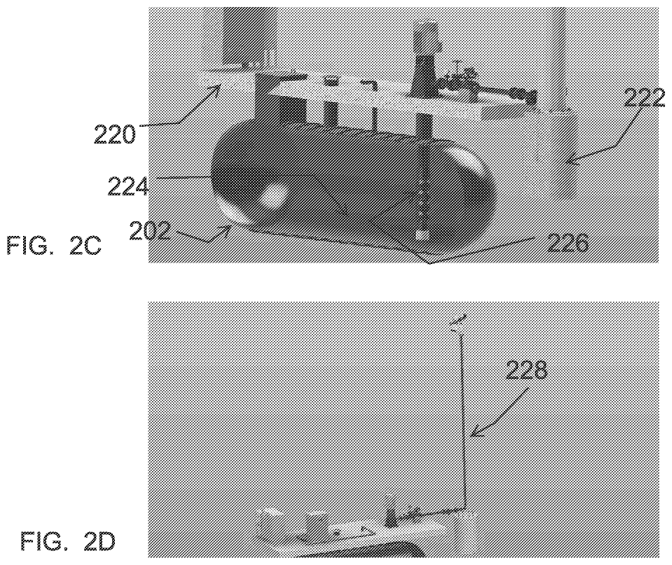

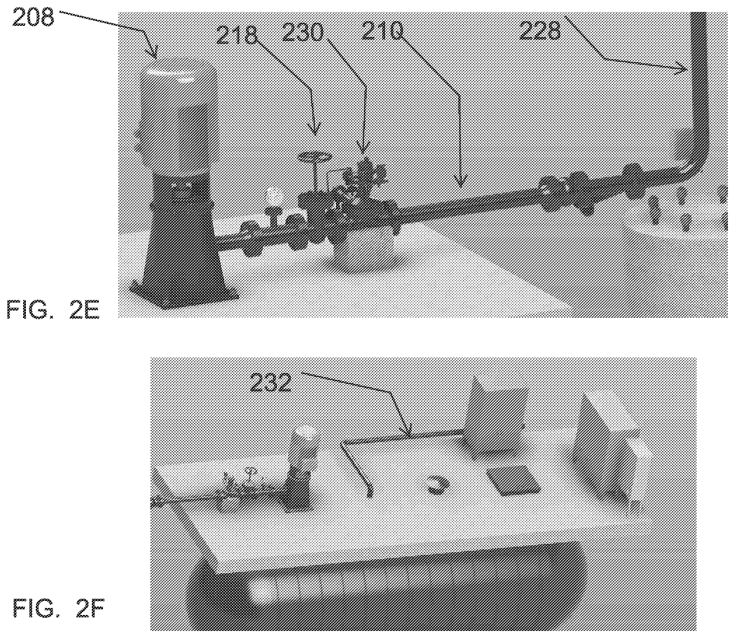

Referring to FIGS. 2A through 2F, an illustration of a wildfire suppression system 200 including a below ground tank 202 is illustrated. One implementation of the technology as disclosed and claimed herein includes a nozzle/cannon tower 204 and a power plant 212, 214 and 216. The system 200 includes a vertical pump with discharge head and multistage bowl 208 and a flow control channel 210. The flow control channel 210 includes a shut off valve 218. FIG. 2C illustrates a sectional view of the tank 202, thereby disclosing the interior and the interior of the tank wall 224. A syphoning channel 226 is also disclosed that is utilized to channel the fire suppressant substance from the interior volume of the tank to the cannon for dispensing the fire retardant substance. The power plant is supported by a concrete pad 220. The tower 204 is supported by a concrete pillar 222. The elevation channel 228 receives retardant substance from the flow control channel 210. Flow control channel 210 controls the flowrate and pressure of the fire suppressant substance flowing from the tank and through the nozzle assembly 206. Item 232 is a power supply line.

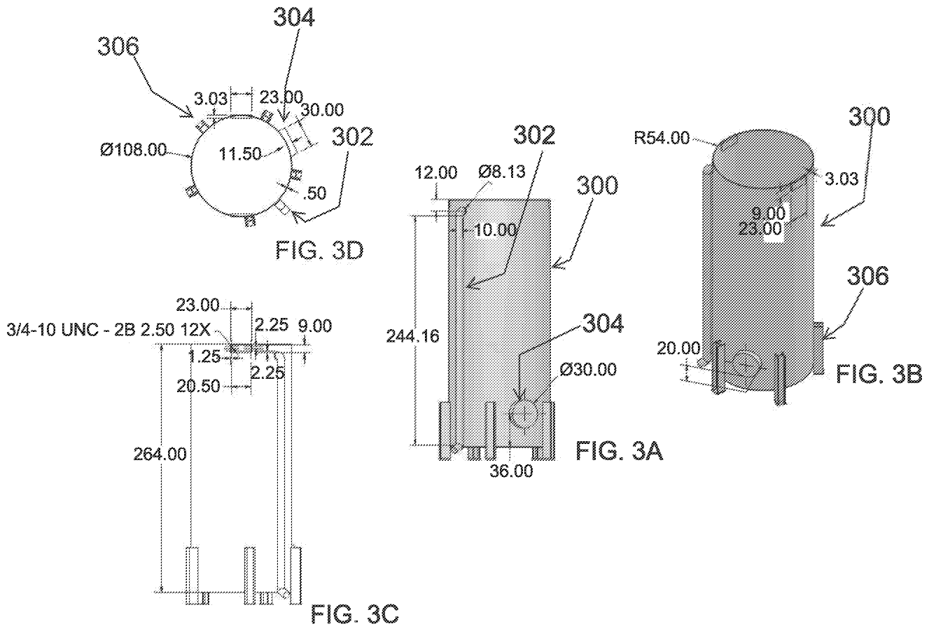

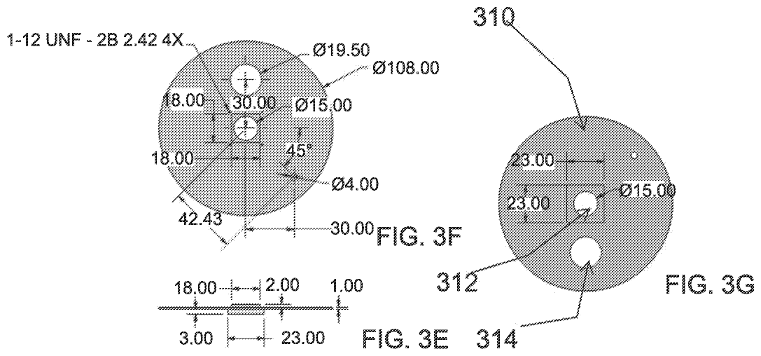

FIGS. 3A through 3E are an illustration of an above ground tank 300 showing one implementation for dimensions as shown, but not intended to limit the size of the vessel or the scope of any claims. The tank 300 includes a pressure relief channel 302 and a drain opening 304. The feet 306 of the tank are bolted to a concrete pad for support and stability. A top 310 for the tank is disclosed in FIGS. 3E through 3G illustrating the tank exit opening 312 and vent opening 314.

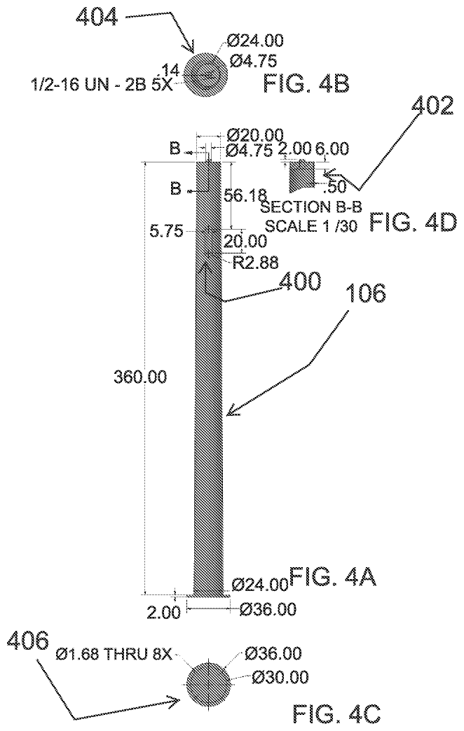

FIGS. 4A through 4D provide an illustration of a nozzle/water cannon tower 106 for a system with an above ground tank. A section view of the top portion 402 of the tower illustrates the interior. The top cap 404 of the tower and the mounting flange 406 is also illustrated. Also, the access port 400 for the flow control channel is also illustrated.

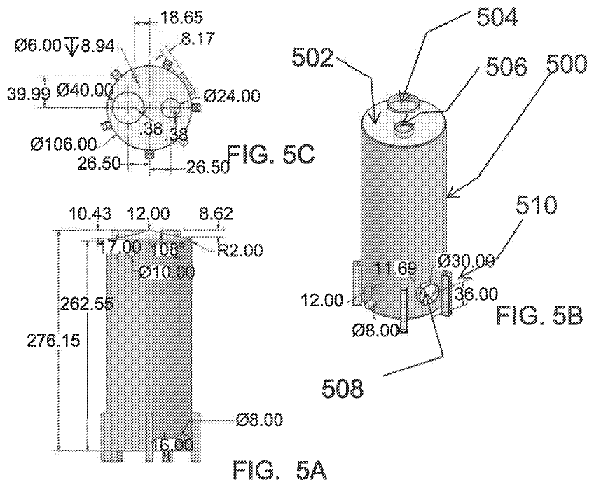

FIGS. 5A through 5C are an illustration of an above ground tank 500 with the top cap 502 showing one implementation for dimensions as shown, but not intended to limit the scope of the size of the vessel. The tank 500 includes a pressure relief channel and a drain opening 508. The feet 510 of the tank are bolted to a concrete pad for support and stability. A top 502 for the tank is disclosed illustrating the tank exit opening 504 and vent opening 506.

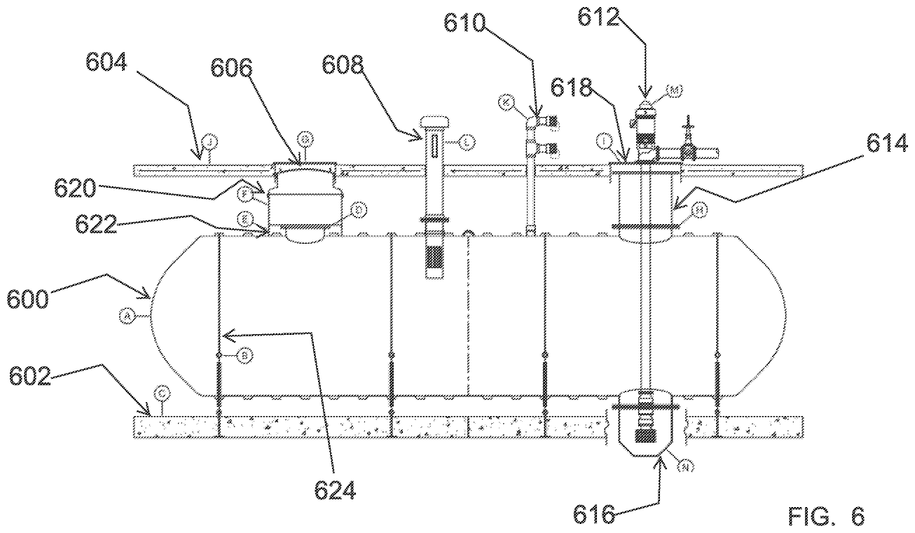

FIG. 6 is an illustration of a below ground tank 600. The tank is secure on and supported by a concrete pad 602. The tank includes a bottom sump 616 and vertical pump with discharge head and multi-stage bowl 612. A flanged manway extension 614 extends from the tank to the surface and is closed off with a manhole cover 618. The tank includes an extension to the surface with dual fill and recirculate points 610. The tank also includes an extension for a fitting with level indicator assembly 608. The tank also includes a containment collar 622 connected to a flanged manway that extends to a tank sump 620 with an opening to a manhole and cover 606. The ground surface above the tank is capped with a concrete apron 604. The above ground tank can have similar components and functions that are configured above ground.

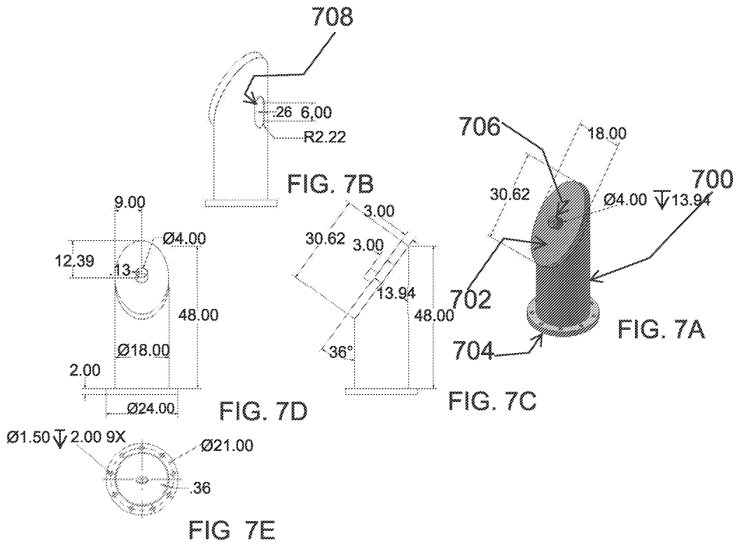

FIGS. 7A through 7E are an illustration of a tower top end 700 for a tower installed on a hill side. The top surface or top cap 702 of the tower top end 700 is configured with a downward angle or slope with respect to horizontal. The top cap 702 has a center exit port 706 and the top end 700 has a mounting flange 704. Projecting outward from the top surface or top cap 702 is an exit portal 706. The tower top end 700 includes an input port 708 for receiving a fire retardant substance therethrough.

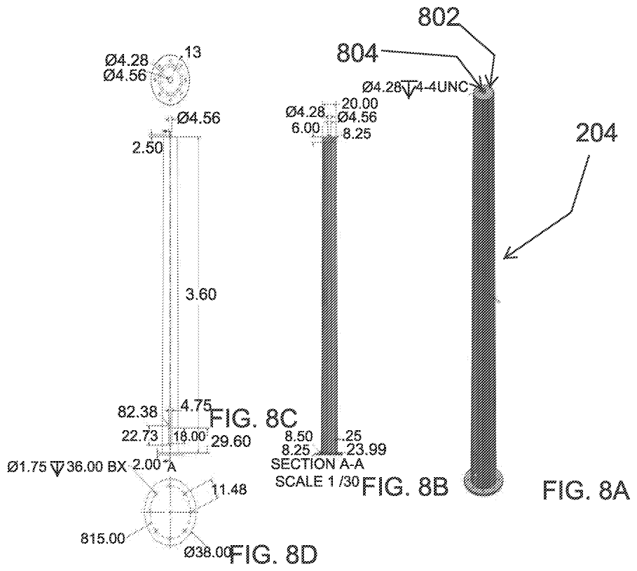

FIGS. 8A through 8D are an illustration of a nozzle/water cannon tower 204 for a system with a below ground tank. The tower 204 has a tower top cap 802. Protruding from the top cap 802 is an exit port 804.

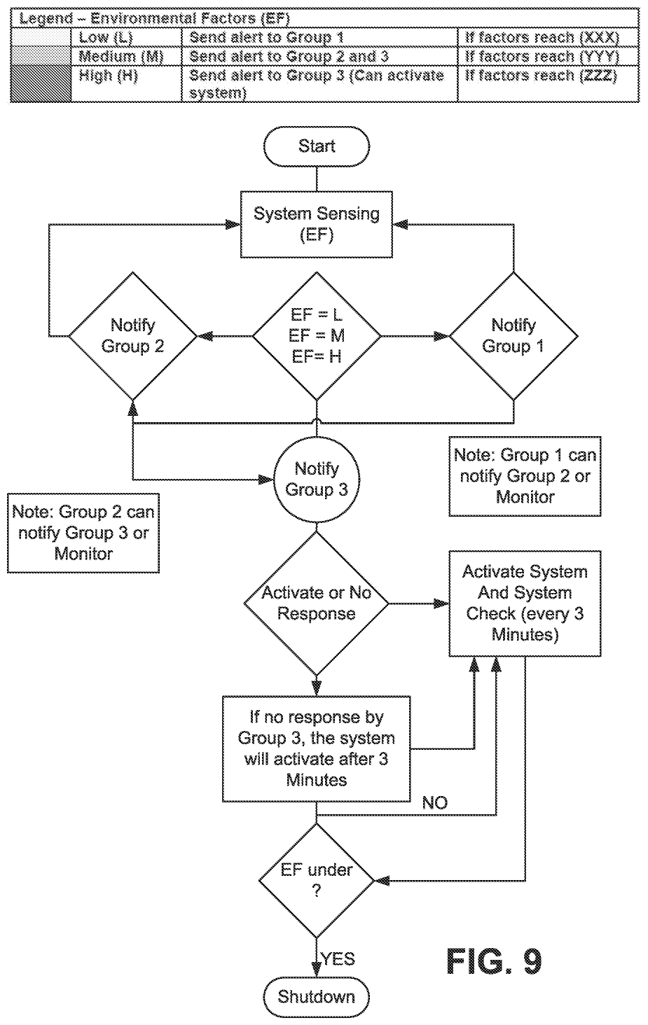

FIG. 9 is an illustration of the process flow for system and surrounding environmental monitoring and system activation. Various sensors are placed in an area surrounding the area to be protected. The self-activating technology includes field sensors and an onsite computer modified with controller hardware and software. The sensors detect various environmental factors (EF) such as, field sensors measure air temperature, ground temperature, wind velocity and direction, barometric pressure, temperature of the fire area, heat release rate, height of flames, oxygen/nitrogen levels, oxygen/nitrogen consumption (molar flow rates of incoming gases vs exhaust gases) rates, relative humidity, air temperature (91° F.), direction of advancement of fire and specific heat capacities and relative humidity. The data is fed to an onsite computer modified with hardware and software that analyzes the data then determines various characteristics of the fire based on the sensor data, including temperature, direction and speed of approach, thereby determining the category of wildfire, the threat level and then determines the optimal spray pattern and direction of spray. After a fire has been mitigated, the computer is programmed to deactivate the system and algorithms are executed to control the sensors to perform a scan of the affected area to determine potential re-flash conditions. The environmental factors are analyzed and a threat level is determined as Low (L), Medium (M) and High (H). Group 1 and Group 2 and Group 3 are notified with a threat level of L, M or H. For redundancy, Group 1 can notify Group 2 and Group 2 can notify Group 3. Group 3 provides an activate signal or no response. If no response, a system check is performed every 3 minutes. If an activate signal is provided and the EF is above a threshold value then the system is activated, however, if an activate signal is provided, but the EF level is below the threshold value then the system is shutdown.

One implementation for environmental factors for the system's activation process includes:
Low (Group 1)—An area has been identified that has a constant or increasing temperature of at least 10° above its immediate surrounding ambient temperature. If the temperature stays constant or does not increase more than 10° over a (1) min cycle, then the system will continue to monitor. If the temperature increases more than 10° within the (1) min cycle, then Group 2 is notified.
Medium (Group 2)—An area has been identified that has a constant or increasing temperature of at least 275° F. If the temperature stays constant or does not increase more than 10° over a 30 sec cycle, then the system will continue to monitor. If the temperature increases more than 10° over a 30 sec cycle then Group 3 is notified.
   If notified from Group 1, the system initiates the data compiling sequence over a (1) min cycle. The computer analyzes the compiled data, then either continues to monitor, notifies Group 3 or initiates the Activation Sequence.
High (Group 3)—An area has been identified that has a constant or increasing temperature of at least 400° F. The computer will initiate the Activation Sequence
   If notified from Group 2, the system initiates the data compiling sequence over a 15 sec cycle. The computer analyzes the compiled data, then either continues to monitor or initiate the Activation Sequence.
Activation Sequence—The system will alert the Fire Department personnel attached to the area through mobile device and/or fire station alert system with a confirm or deny to activate request. The system has a (1) min time limit on response before automatic activation. If the fire department personnel deny the request, the system will begin the process again starting with Group 2 through the activation process. If the fire department personnel deny the request a second time, the system initiates Self-Prev mode which it will auto-activate if the fire gets within a certain range of the system.
Deactivation Sequence—Once all monitored areas have constant temperatures at or below ambient temperatures, the system will send a request to deactivate to the fire department personnel. The system has a (1) min time limit on response before it will auto-deactivate.

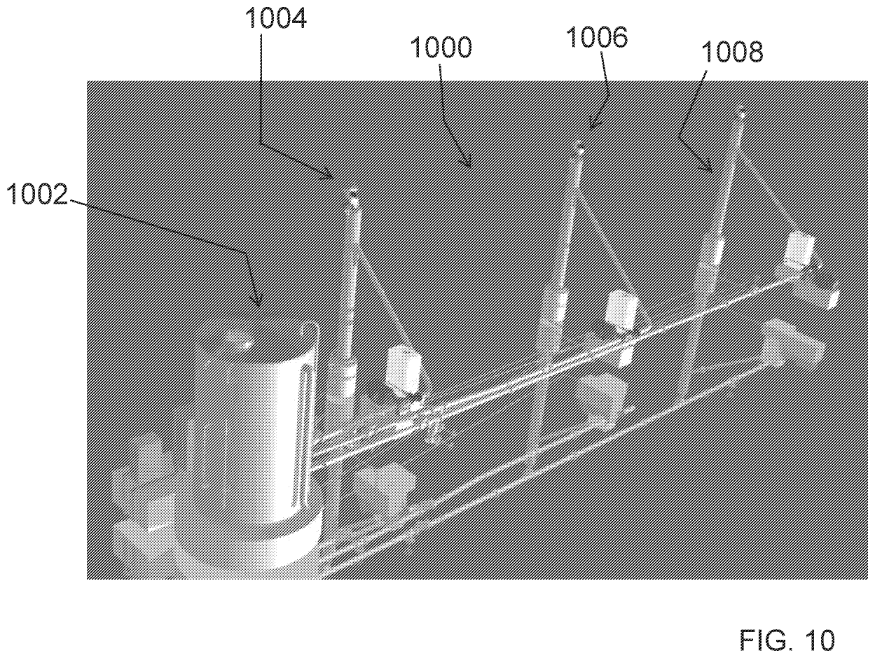

FIG. 10 is an illustration of a system 1000 with three dispensing towers 1004, 1006 and 1008. The three dispensing towers are supplied by a tank 1002, which contains a fire retardant substance such as water.

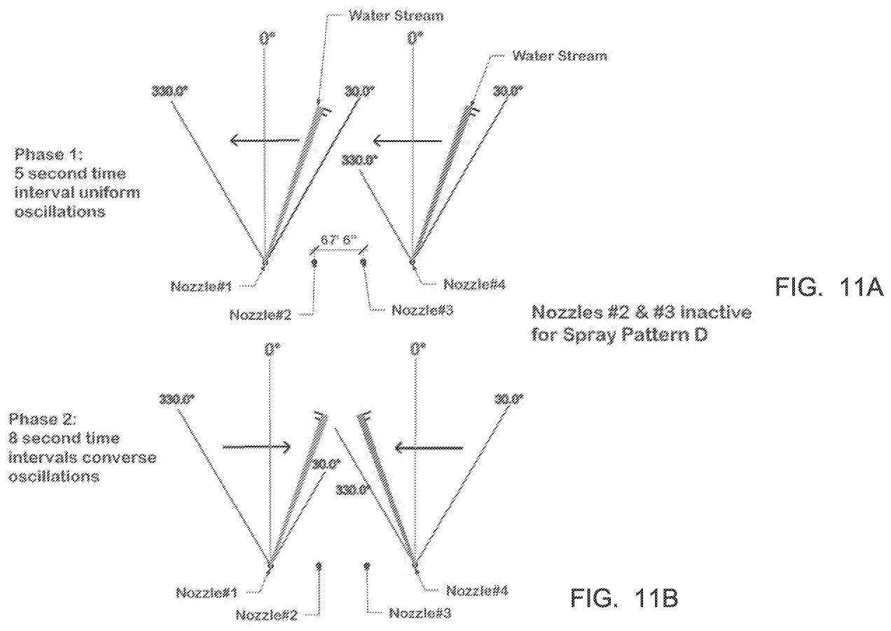

FIGS. 11 through 24 provide various spray patterns for various wildfire scenarios. FIGS. 11A and 11B are an illustration of Spray Pattern D, which can be executed by a two to four nozzle system. For the Deluge (D) spray pattern 4NS, nozzles #1 and #4 starting at 20°-40° off 0° center, and begin oscillation in a counterclockwise direction, perform a uniform circular oscillatory motion of 50°-70° span between 20°-40° and 320°-340° at 4-7 sec time intervals for 4 complete oscillations. Then nozzle #4 slows to a 7-8 sec time interval while second nozzle maintains a 4-7 sec interval until positioned in a converse circular oscillatory motion to nozzle #1. Then both nozzles oscillate at a 6-9 sec time interval until wildfire is extinguished. Nozzles #2 and #3 are inactive during this spray pattern.

This spray pattern is for all LI fires as described in paragraph [0043]. The spray pattern, oscillatory motion and time interval ranges can vary by 10-20 percent for each of the spray patterns described herein depending on the environmental conditions and terrain in the wildfire area.

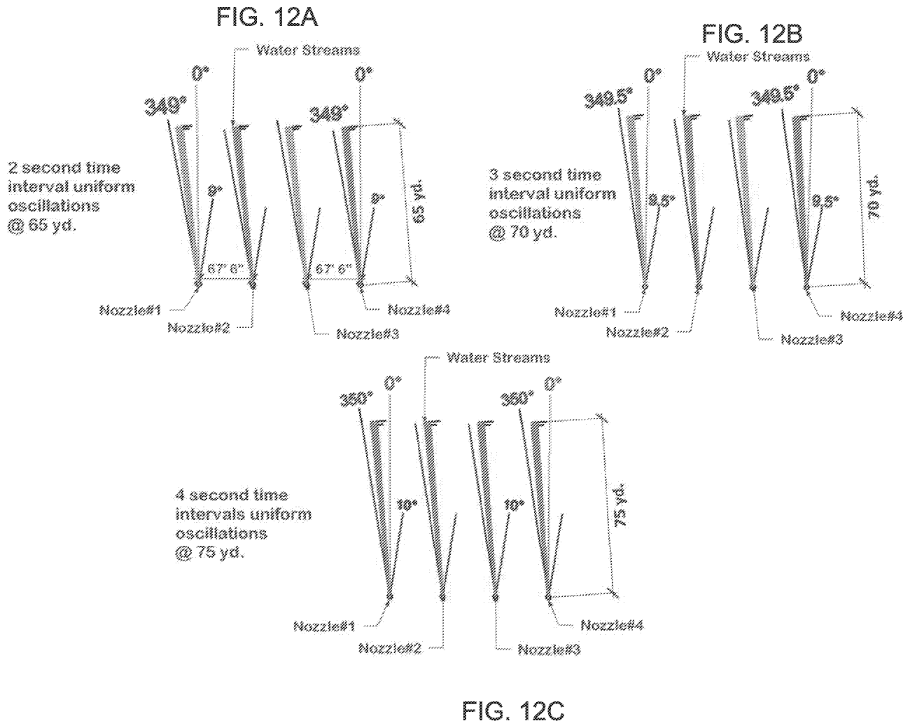

FIGS. 12A through 12C are an illustration of Spray Pattern M, which can be executed with a four nozzle system. For the Monsoon (M), 4NS, spray pattern system, all nozzles on a 4NS perform a graduated increase in distance of throw, size of span and time interval. All nozzles starting at 5°-15° off 0° center, begin oscillations in a counterclockwise direction, and perform a uniform circular oscillatory motion with a 10°-30° span between 9 degrees and 349 degrees at a 2-4 sec interval for 2 complete oscillations beginning at 60-70 yds. Then the throw distance increases to 70-80 yds with a 18-20 degree span 3-5 sec intervals for 2 complete oscillations. Then the throw distance increases to 70-90 yds with an 18-20 degree span between 10 degrees and 350 degrees for 3-5 sec intervals until wildfire is extinguished. This spray pattern is for MI to HI fires with moderate ember production. This pattern drenches the unburned fuel in the path of fire inside the WCA before reaching full throw distance.

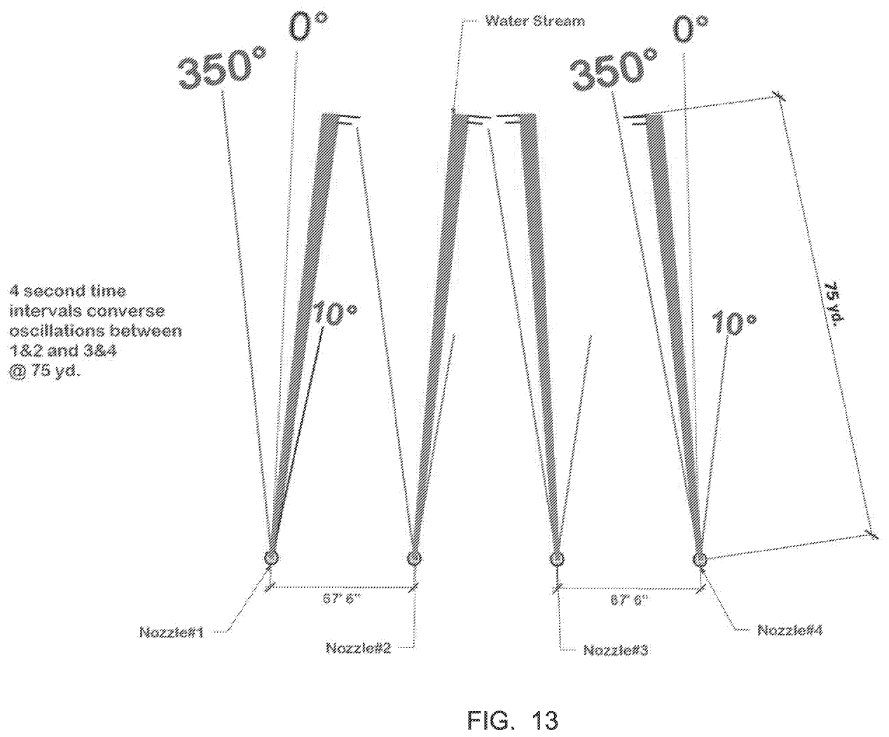

FIG. 13 is an illustration of Spray Pattern T, 4NS, which can be executed with a four nozzle system. For the Torrent (T) spray pattern, nozzles #1 & #2 oscillate in a converse or opposed motion to nozzles #3 & #4 oscillation. Nozzles #1 & #2 starting between 5°-15° off 0° center, and begin oscillation in a counterclockwise direction and uniformly oscillate between 5°-15° and 340°-359°. Nozzles #3 & #4 starting between 340°-359° off 0° center, begin oscillation in a clockwise direction and uniformly oscillate between 340°-359° and 5°-15°. All nozzles maintain a 3-5 sec time interval until wildfire is extinguished. This spray pattern is for MI to HI fires with low to moderate ember production, high wind event, fast-moving.

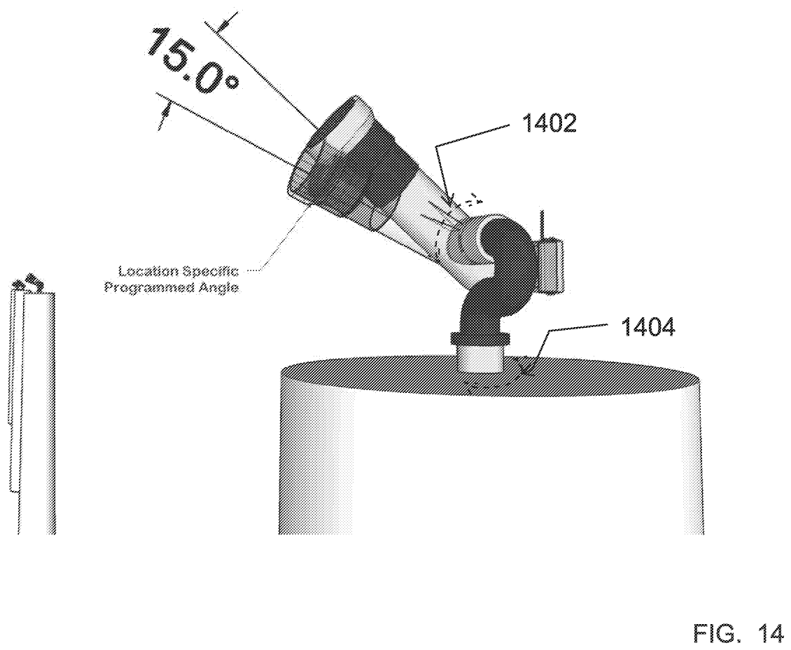

FIGS. 14 and 5 are an illustration of an initial Spray Pattern F, 4NS, proceeding all other spray patterns. For the Fogg (F) spray pattern, an Initial (I) spray pattern, precedes all other spray patterns. All nozzles angled 10°-20° above the location specific programmed angle, which is based on the slope of the local terrain. Nozzles #1 and #2 oscillate in a converse or opposed motion to nozzles #3 and #4 oscillation. Nozzles #1 and #2 starting between 5°-15° off 0° center, begin oscillation in a counterclockwise direction and uniformly oscillate between 5°-15° and 340°-359°. Nozzles #3 and #4 starting between 340°-359° of 0° center, begin oscillation in a clockwise direction and uniformly oscillate between 340°-359° and 5°-15°. All having 2-4 sec time intervals until ember threat or wind driven flames have been minimized. This spray pattern is for MI to HI fires with high wind, high ember production, fast-moving, low humidity. Directional arrows 1402 and 1404 illustrate two axes of rotation.

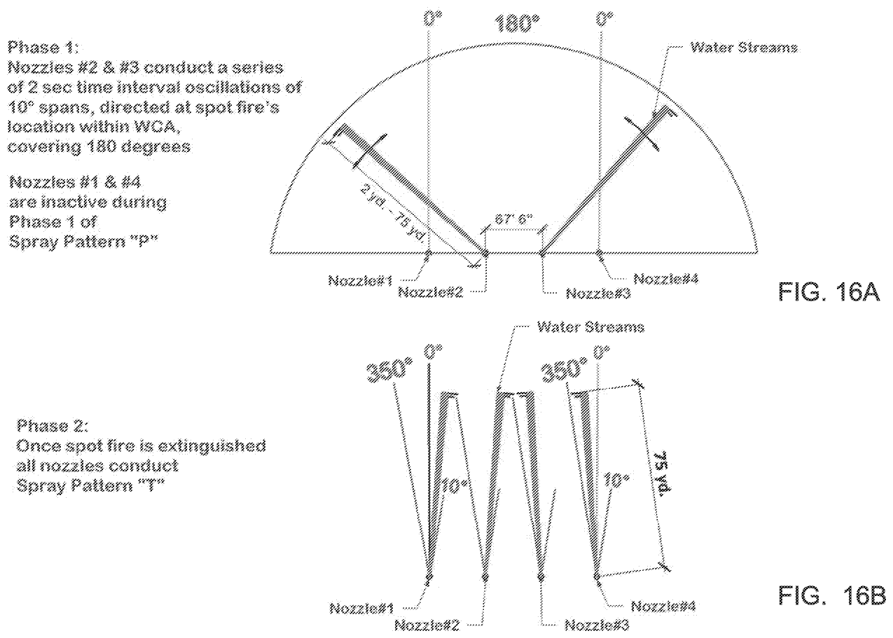

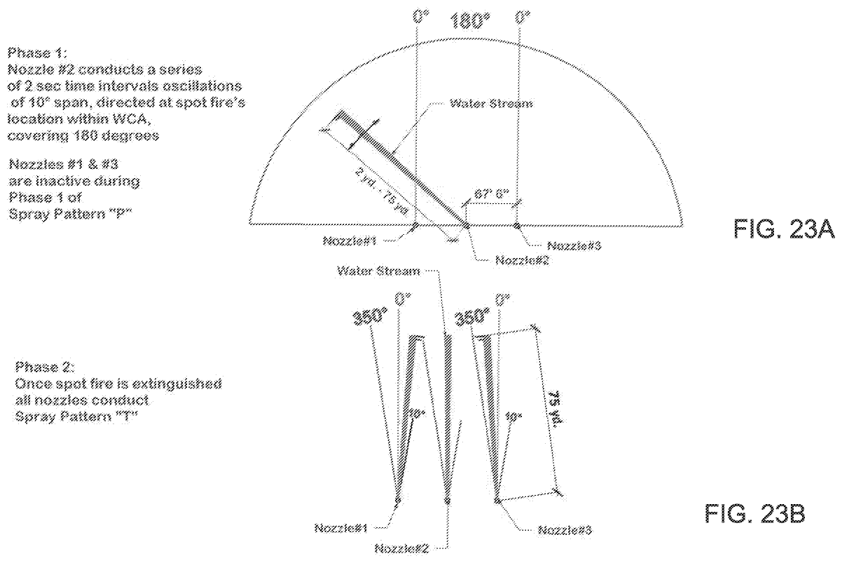

FIGS. 16A and 16B are an illustration of Spray Pattern P. For the Protect (P), heat sensors determine location of spot fire within the Water Coverage Area. Nozzles #2 and/or #3 conduct a series of 2-3 sec time interval oscillations of 5°-15°, directed at spot fire's location until spot fire is extinguished. Nozzle usage is determined by spot fire's location compared to centerline of system. If spot fire's location is between two systems, then nozzle #2 or #3 on a 4NS and nozzle #2 on a 3NS system (see below, FIGS. 23A and 23B) will conduct Spray Pattern P until spot fire is extinguished. Once spot fire is extinguished, system conducts Spray Pattern T until all wildfire is extinguished.

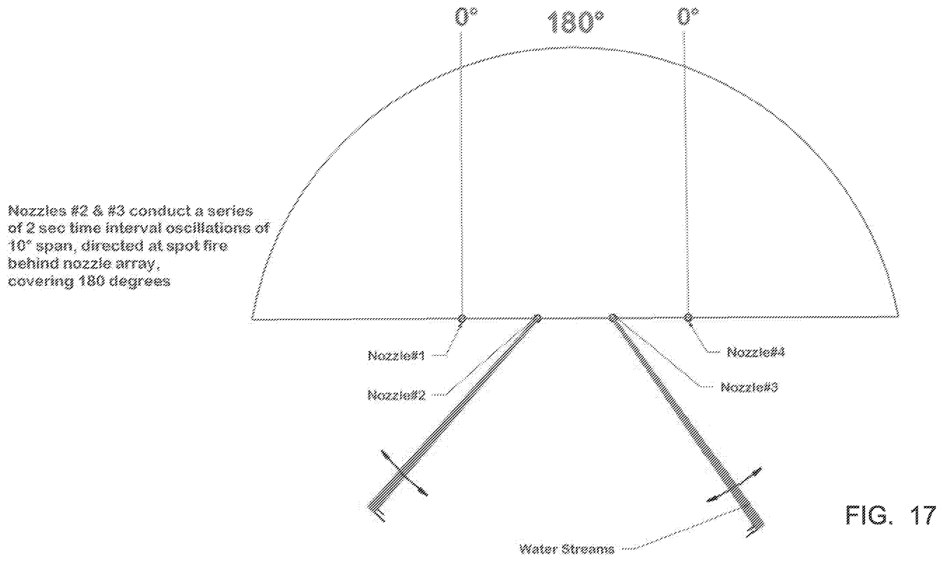

FIG. 17 is an illustration of Spray Pattern R, for a 4NS system. For the Reversed (R) coverage, if a fire is detected behind the nozzle array, nozzles in closest proximity to spot fire will rotate up to 270°, and conduct first phase of Spray Pattern “P” until spot fire is extinguished.

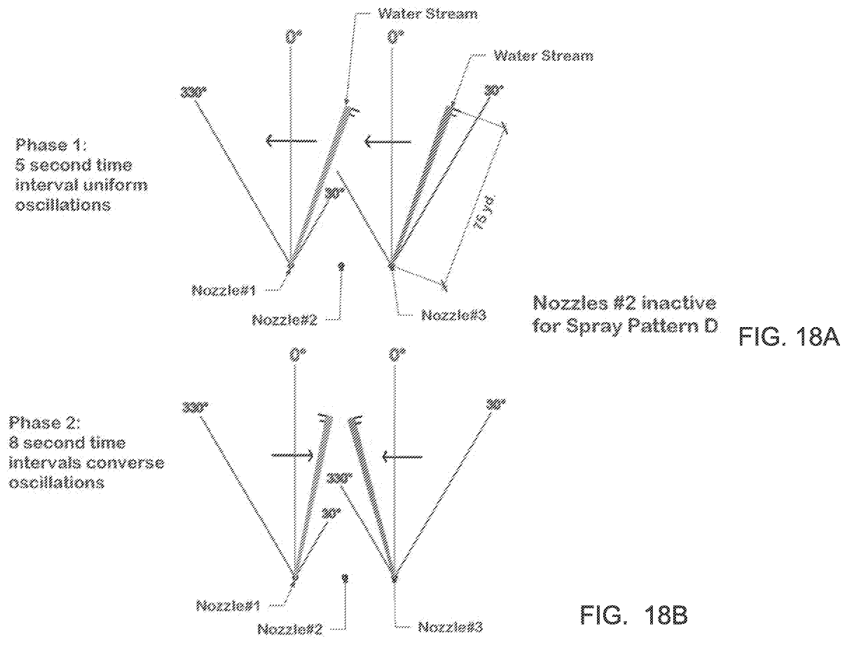

FIGS. 18A and 18B are a further illustration of Spray Pattern D for a 3NS system. For the Deluge (D), 3NS spray patter, nozzles #1 and #3 starting between 20°-40° off 0° center, begin oscillation in a counterclockwise direction, and perform a uniform circular oscillatory motion of 50-70 degree span between 30 degrees and 330 degrees at 4-6 sec time intervals for 4 complete oscillations. Then one nozzle #3 slows to a 7-9 sec time interval while second nozzle maintains a 4-6 sec interval until positioned to perform a circular oscillatory motion converse to nozzle #1. Then both oscillate at a 7-9 sec time interval until wildfire is extinguished. Nozzle #2 is inactive for this spray pattern.

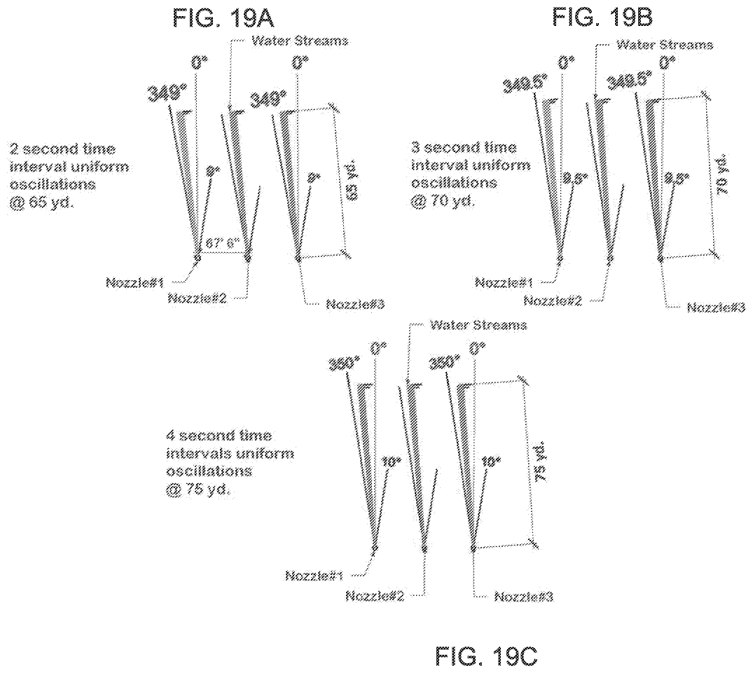

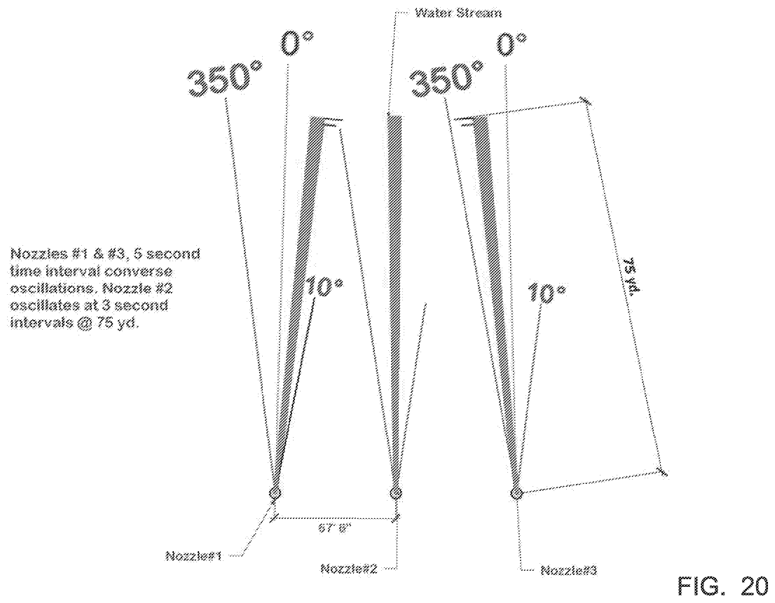

FIGS. 19A through 19C are a further illustration of Spray Pattern M. For the Monsoon (M), 3NS spray pattern, all nozzles on a 3NS system perform a graduated increase in distance of throw, size of span and time interval. All nozzles starting between 5°-15° off 0° center, begin oscillations in a counterclockwise direction, and perform a uniform circular oscillatory motion with a 10-30-degree span between 10 degrees and 350 degrees at a 2-4 sec interval for 2 complete oscillations beginning at 60-69 yds. Then throw distance increases to 70-79 yds with a 18-20-degree span between 9.5 degrees and 349.5 degrees for 2-4 sec intervals for 2 complete oscillations. Then throw distance increases to 70-85 yds with a 18-20-degree span between for 3-5 sec intervals until wildfire is extinguished.

FIG. 20 is a further illustration of Spray Pattern T for a 3NS system. For the Torrent (T), 3NS spray pattern, nozzle #1 oscillates in a converse or opposed motion to nozzle #3 oscillation. Nozzle #1 starting between 5°-15° off 0° center, begins oscillation in a counterclockwise direction and oscillates between 5°-15° and 340°-359°. Nozzle #3 starting between 340°-359° of 0° center, begins oscillation in a clockwise direction and oscillates between 340°-359° and 5°-15°. Both nozzles maintain a 4-6 sec time interval. Nozzle #2 starts at 0°, oscillates in a clockwise direction to 5°-15° then back through 0° to 340°-359° at a 2-4 sec time interval. All nozzles maintain time interval until wildfire is extinguished.

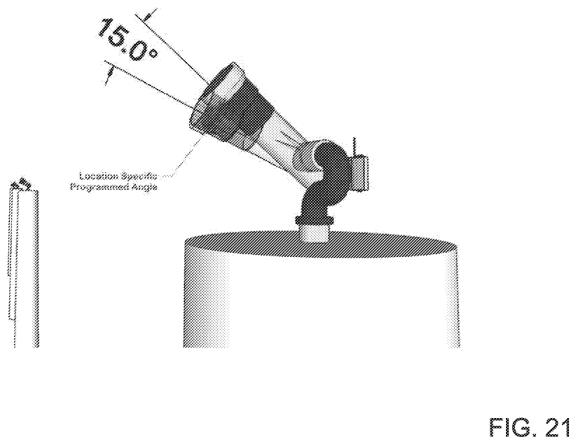

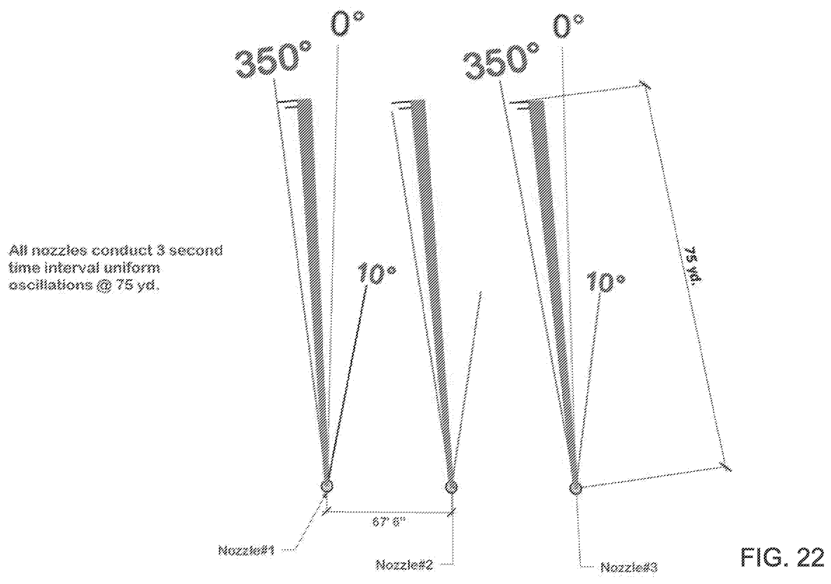

FIGS. 21 and 22 are an illustration of an initial Spray Pattern F, for a 3NS system, in one implementation proceeding all other spray patterns. For the Fogg (F), 3NS spray pattern, an Initial (I) spray pattern precedes all other spray patterns. All nozzles angled between 10°-20° above the location specific programmed angle for terrain type. All nozzles starting at 5°-15° off 0° center, beginning oscillation in a counterclockwise direction, perform a uniform circular oscillatory motion of 50-70-degree span between 10 degrees and 350 degrees at 3-5 sec time intervals. All having 2-4 sec time intervals until ember threat or wind driven flames have been minimized.

FIGS. 23A and 23B are an illustration of Spray Pattern P, for a 3NS system. For the Protect (P), 3NS spray pattern, heat sensors determine location of spot fire within the Water Coverage Area (WCA). Nozzle usage is determined by spot fire's location compared to centerline of system or systems. Phase 1: Nozzle #2 conducts a series of 2-4 sec time interval oscillations of 5°-15° span, directed at spot fire's location until spot fire is extinguished. If spot fire's location is between two systems then nozzle #2 on a 3NS system and nozzle #2 or #3 on a 4NS system will continue Spray Pattern until spot fire is extinguished. Phase 2: Once spot fire is extinguished, system conducts Spray Pattern T until all wildfire is extinguished.

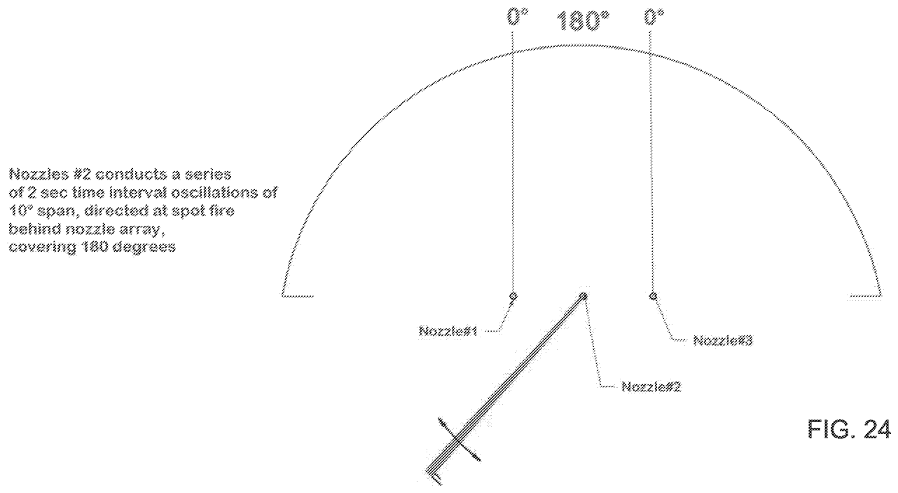

FIG. 24 is an illustration of Spray Pattern R, for a 3NS system. For the Reversed (R) coverage, 3NS system, if a fire is detected behind nozzle array, nozzles in closest proximity to spot fire will rotate up to 270°, use first phase of Spray Pattern “P” until spot fire is extinguished.

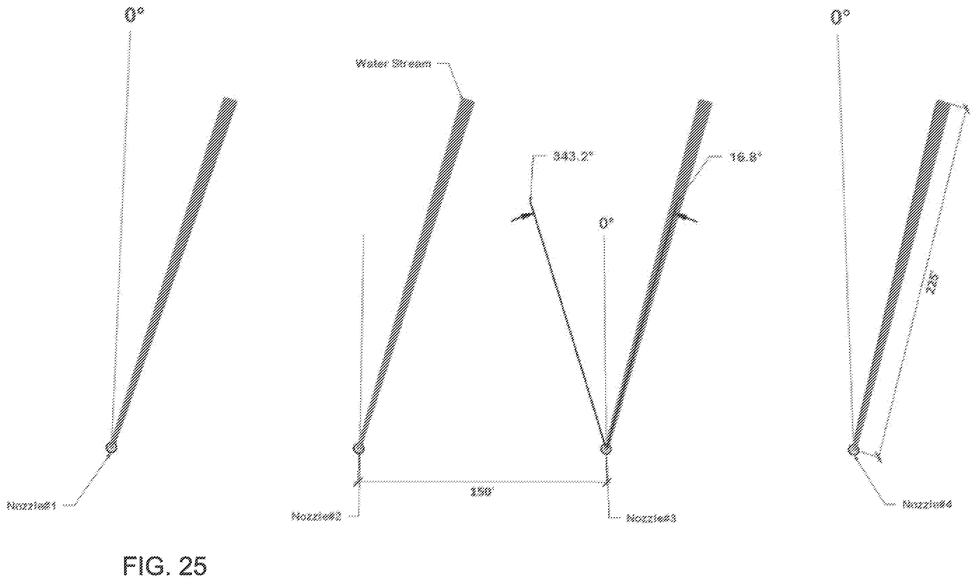

FIG. 25 is an illustration of Spray Pattern W (Wide Extended), which can be 4 or 3 nozzle systems. All nozzles begin spraying directly toward the direction of the approaching fire threat. All nozzles uniformly oscillate between 16.8°-343.2° off 0 degrees center at a rate of about approximately 3.3 yd/s until the fire is extinguished. The spray pattern is designed to be used for MI and HI fires with high wind and high ember production, fast moving, and low humidity. Also used if the fire is approaching from single or multiple directions other than straight ahead. If the fire is approaching from only straight ahead, then spray pattern Z can be used.

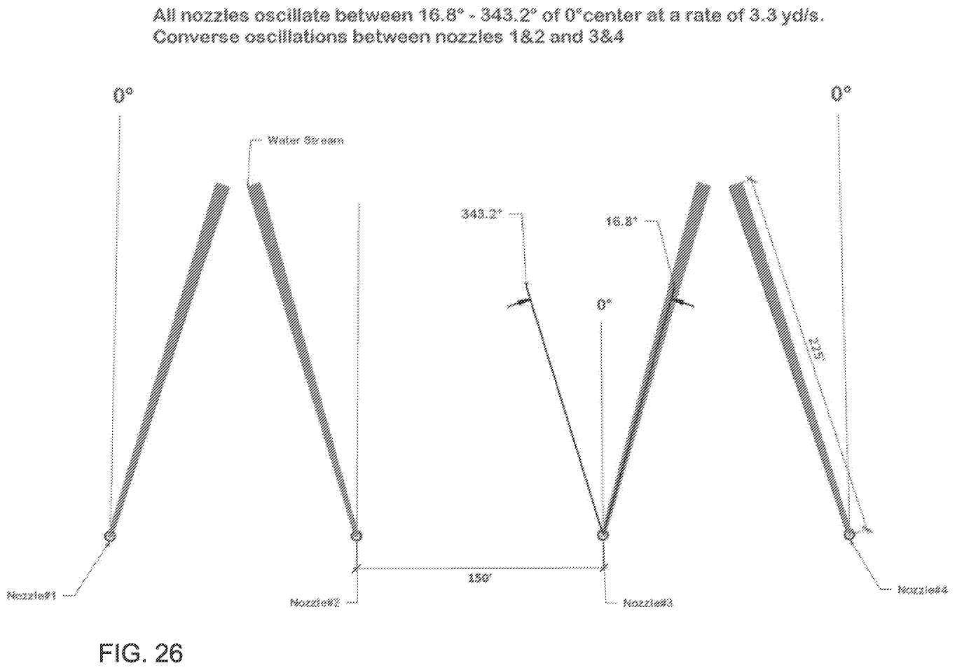

FIG. 26 is an illustration of Spray Pattern Z (Zenith), which is a 4 nozzle system. All nozzles begin spraying at 0 degrees center. All nozzles oscillate between 16.8 degrees to 343.2 degrees off 0 degrees center at a rate of 3.3 yd/s until the fire is extinguished. Converse oscillations are conducted between nozzles 1 and 2, and 3 and 4 for the duration. This spray pattern is used for MI and HI fires with high wind, high ember production, fast moving, and low humidity. Also used if the fire is approaching from only straight ahead. If the fire is approaching from single or multiple directions other than straight ahead, then spray pattern W is used.

The various implementations and examples shown above illustrate a method and system for a wildfire suppression system. A user of the present method and system may choose any of the above implementations, or an equivalent thereof, depending upon the desired application. In this regard, it is recognized that various forms of the subject wildfire suppression method and system can be utilized without departing from the scope of the present technology and various implementations as disclosed.

As is evident from the foregoing description, certain aspects of the present implementation are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the scope of the present implementation(s). Accordingly, the specification and drawings are to be regarded in an illustrative rather than a restrictive sense.

Certain systems, apparatus, applications or processes are described herein as including a number of modules. A module may be a unit of distinct functionality that may be presented in software, hardware, or combinations thereof. When the functionality of a module is performed in any part through software, the module includes a computer-readable medium. The modules may be regarded as being communicatively coupled. The inventive subject matter may be represented in a variety of different implementations of which there are many possible permutations.

The methods described herein do not have to be executed in the order described, or in any particular order. Moreover, various activities described with respect to the methods identified herein can be executed in serial or parallel fashion. In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

In an example implementation, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine or computing device. Further, while only a single machine is illustrated, the term “machine” shall also be taken to include any collection of machines that individually or jointly execute a set (or multiple sets) of instructions to perform any one or more of the methodologies discussed herein.

The example computer system and client computers can include a processor (e.g., a central processing unit (CPU), a graphics processing unit (GPU) (or both), a main memory and a static memory, which communicate with each other via a bus. The computer system may further include a video/graphical display unit (e.g., a liquid crystal display (LCD) or a cathode ray tube (CRT)). The computer system and client computing devices can also include an alphanumeric input device (e.g., a keyboard), a cursor control device (e.g., a mouse), a drive unit, a signal generation device (e.g., a speaker) and a network interface device.

The drive unit includes a computer-readable medium on which is stored one or more sets of instructions (e.g., software) embodying any one or more of the methodologies or systems described herein. The software may also reside, completely or at least partially, within the main memory and/or within the processor during execution thereof by the computer system, the main memory and the processor also constituting computer-readable media. The software may further be transmitted or received over a network via the network interface device.

The term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform any one or more of the methodologies of the present implementation. The term “computer-readable medium” shall accordingly be taken to include, but not be limited to, solid-state memories, and optical media, and magnetic media.

As is evident from the foregoing description, certain aspects of the present technology as disclosed are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the scope of the present technology as disclosed and claimed.

Other aspects, objects and advantages of the present technology as disclosed can be obtained from a study of the drawings, the disclosure and the appended claims.

What is claimed is:

1. An apparatus for wildfire suppression comprising:
a tank storing a fire retardant substance;
an elevated tower having a height of 15 feet or higher;
a nozzle cannon assembly disposed proximate a top portion of the elevated tower, and said nozzle cannon assembly including a nozzle mounted on a horizontally oriented bearing and said nozzle cannon assembly having a motor operative to controllably pivot said nozzle along a vertical arc about said horizontally oriented bearing and said nozzle cannon assembly further mounted on a vertically oriented bearing and said nozzle cannon assembly having said motor operative to controllably pivot said nozzle along a horizontal arc about said vertically oriented bearing;
a pump operative to controllably pump the fire retardant substance from the tank through the nozzle of the nozzle cannon assembly and project the fire retardant material at a distance from the elevated tower; and
a controller including executable code such than when executed controls the motor, the nozzle and nozzle cannon assembly to stepwise pivot the nozzle about the vertical and horizontal bearings respectfully with an oscillating pattern and said controller further controls the pump to pump the fire retardant substance from the tank and through the nozzle at a desire flow rate and pressure.

2. The apparatus for wildfire suppression as recited in claim 1, comprising:
a system of field sensors operable to measure one or more of the air temperature, the ground temperature, the wind velocity and direction, the barometric pressure, the temperature of the fire area, heat release rate, height of flames, oxygen/nitrogen levels, oxygen/nitrogen consumption (molar flow rates of incoming gases vs exhaust gases) rates, relative humidity, air temperature, specific heat capacities and relative humidity,
where the controller controls sensor data to be fed to an onsite computing system that has modified hardware and software that analyzes the data and then determines and controls the controller to execute the optimal spray pattern and direction of spray and where the computing system is programmed to deactivate the wild life suppression system and algorithms are executed to direct the field sensors to perform a scan of the affected area to determine potential re-flash conditions.

3. The apparatus for wildfire suppression as recited in claim 2, comprising:
an independent stand-alone power generation system for powering the wildfire suppression system.

4. The apparatus for wildfire suppression as recited in claim 2, where the tank is a tall above ground tank and the elevated tower is over 25 feet in height.

5. The apparatus for wildfire suppression as recited in claim 2, comprising:
a heat and vision system array for sensing an oncoming wildfire disposed proximate a highest point of an elevated tank or the elevated tower.

6. The apparatus for wildfire suppression as recited in claim 2, where said tank is one of an above ground elevated tank and a below ground tank.

7. The apparatus for wildfire suppression as recited in claim 2, where the fire retardant substance is one of water and a fire retardant foam.

8. The apparatus for wildfire suppression as recited in claim 2, where the computing system is programmed with software algorithms for calculating one or more of air temperature, ground temperature, wind velocity, wind direction, barometric pressure, temperature of the fire area, heat release rate, height of flames, oxygen/nitrogen levels, oxygen/nitrogen consumption (molar flow rates of incoming gases vs exhaust gases) rates, relative humidity, air temperature (91° F.), direction of advancement of fire and specific heat capacities based on the one or more field sensors.

2. apparatus for wildfire suppression as recited in claim 2, comprising a redundant wildfire suppression apparatus.

10. The apparatus for wildfire suppression as recited in claim 9, where the computing system of the wildfire suppression apparatus is communicably coupled with a redundant computing system of the redundant wildfire suppression apparatus.

11. A method for wildfire suppression comprising:
controlling with a controller a pump to pump a fire retardant substance from a tank through a conduit extending the height of an elevated tower and through a nozzle of a nozzle cannon assembly disposed proximate a highest point of an elevated tower having a height of 15 feet or higher;
controlling with the controller a motor to drive the nozzle to stepwise pivot along a vertical arc and to stepwise pivot along a horizontal arc;
controlling the pump to project the fire retardant substance at a distance from the elevated tower;
executing code with the controller to control the motor to drive the nozzle to stepwise pivot about the vertical and horizontal arcs with a predetermined oscillating pattern; and
executing code with the controller to control the pump to pump the fire retardant substance at a predetermined flow rate and pressure.

12. The method for wildfire suppression as recited in claim 11, comprising:
receiving at a computing system sensor data from one or more field sensors positioned to sense environmental conditions of a wildfire area;
analyzing the sensor data received from the one or more field sensors and determining a type of wildfire condition based on predefined stored parameters;
determining the appropriate spray response pattern and corresponding flowrate based on the determined type of wildfire condition; and
transmitting command logic to the controller for execution and thereby causing the controller to drive the nozzle to stepwise pivot about the vertical and horizontal arcs with a predetermined oscillating pattern corresponding with the determined spray response pattern, and executing code with the controller to control the pump to pump the fire retardant substance at a predetermined flow rate and pressure.

13. The method for wildfire suppression as recited in claim 12, where the wildfire type is one of High, Medium or Low.

14. The method for wildfire suppression as recited in claim 12, where the spray response pattern is one of a D 4NS pattern, a M 4NS pattern, a T 4NS pattern, a F 4NS pattern, a P 4NS pattern, a D 3NS pattern, a M 3NS pattern, a T 3NS pattern, a F 3NS pattern, a P 3NS pattern, a R 3NS pattern, a W pattern or a Z pattern.

15. The method for wildfire suppression as recited in claim 12, where the sensor data is received from a system of field sensors transmitting data representative of one or more of the air temperature, the ground temperature, the wind velocity and direction, the barometric pressure, the temperature of the fire area, heat release rate, height of flames, oxygen/nitrogen levels, oxygen/nitrogen consumption (molar flow rates of incoming gases vs exhaust gases) rates, relative humidity, air temperature, specific heat capacities and relative humidity, and
where the computing system has modified hardware and software that analyzes the data and then determines and controls the controller to execute the optimal spray pattern and direction of spray and where the computing system is programmed to deactivate the wild life suppression system and algorithms are executed to direct the field sensors to perform a scan of the affected area to determine potential re-flash conditions.

16. The method for wildfire suppression as recited in claim 12, comprising:
monitoring with the computing system field sensors for reflash conditions and transmitting corresponding command signals to the controller.

17. The method for wildfire suppression as recited in claim 12, comprising:
communicating activation and deactivation commands between the computing system and a redundant computing system and a corresponding redundant fire suppression system.
